(19) United States
(12) Patent Application Publication
(10) Pub. No.: US 2012/0310676 A1
(43) Pub. Date: Dec. 6, 2012

(54) SYSTEM AND COMPUTER-IMPLEMENTED METHOD FOR AUDITING WORKERS' COMPENSATION RELATED INVOICES

(75) Inventors: Jane Eastman Britton, West Hartford, CT (US); Kurtis J. Braddy, Lake Mary, FL (US)

(73) Assignee: Hartford Fire Insurance Company, Hartford, CT (US)

(21) Appl. No.: 13/150,801

(22) Filed: Jun. 1, 2011

(51) Int. Cl. G06Q 40/00

(52) U.S. Cl. 705/4

(57) ABSTRACT

Disclosed herein are processor-executable methods, computing systems, and related technologies that may be used to audit invoices that have been repriced by Preferred Provider Organizations (PPOs). The invoices relate to services that were rendered pursuant to a workers' compensation insurance policy issued by an insurance company. Data related to invoices that have been repriced by PPOs are stored in a database, and an audit application is used to audit the invoices by analyzing the data stored in the database. Auditing the data may include determining whether the repricing was performed accurately, and assembling and storing data that reflects the accuracy of the repricing. After the auditing is performed, reports may be generated based on the audit results. Further, actions may be taken based on the audit results, such as reimbursing service providers for underpaid invoices and/or updating contracts between the insurance company and the PPOs.

### BACKGROUND

Workers' compensation insurance provides benefits such as rehabilitation services and medical care to workers that are injured in the course of their employment. When a worker is injured, the worker may receive care from a number of different service providers, such as doctors, hospitals, and providers of rehabilitative services. When the injured worker receives care from a service provider, the service provider typically sends an invoice to the insurance company that has provided the insurance policy that covers the worker. Depending upon the nature of the insurance policy and other factors, the insurance company may handle processing of the invoice in a number of different ways. For example, if the service provider has received care from a service provider that is a member of a preferred provider organization (PPO), the insurance company may communicate with the PPO to ensure that charges on the invoice are accurate.

A PPO is an organization that includes service providers such as hospitals and doctors that have agreed to provide medical services at reduced rates. Typically, a PPO establishes a reimbursement rate schedule that governs the maximum fees that service providers in the PPO can receive for particular services. An insurance company can contract with a PPO to obtain less expensive health services for those who are covered by workers' compensation policies issued by the insurance company.

If an insurance company receives an invoice related to treatment by a service provider according to a PPO plan, the insurance company may send the invoice to the PPO to ensure that the invoice reflects fees that are consistent with the PPO's reimbursement rate schedule. If the invoice includes, for example, charges that are higher than what is specified by the reimbursement rate schedule, the PPO will reprice the invoice accordingly, and then send the invoice back to the insurance company. The insurance company then remits payment to the service provider according to the repriced invoice.

It is in the interest of the insurance company, the service providers, and the PPO that repricing done by the PPO is performed accurately. Therefore, an insurance company that is involved with a PPO may periodically audit repricing done by a PPO. Over time, an insurance company may send many (on the order of hundreds of thousands or even millions) of invoices to a PPO for repricing, and the number of invoices involved in even a small-scale audit can quickly become daunting. Further, the sets of rules that govern repricing can be elaborate and complex, and auditing invoices in view of these rules can present significant challenges. Therefore, technologies are required that may be used for auditing the repricing of medical services invoices that overcome the above-mentioned issues.

### SUMMARY

A system for auditing a plurality of workers' compensation invoices includes a communication interface, a processor, and a display device. The invoices include charges for services provided by service providers, relate to a workers' compensation insurance policy issued by an insurance company, and were repriced by a Preferred Provider Organization (PPO). The communication interface is configured to receive information related to an invoice from the plurality of invoices, wherein the information related to the invoice includes, for each of a plurality of services charged on the invoice: an amount to which the PPO repriced the service; an identifier of the invoice; a Current Procedural Terminology (CPT) code; an identifier of a service provider that provided the service; an amount paid by the insurance company to the service provider for the service; and an identifier of a workers' compensation insurance claim associated with the service. The communication interface is further configured to receive information that indicates a reimbursement rate schedule that indicates amounts that the insurance company will pay for services. The processor is configured to determine a correct repricing amount for each of the services based on the reimbursement rate schedule and to determine, for each of the services, a percentage variance between the correct repricing amount and the amount to which the PPO repriced the service. The display device is device configured to display, for each of the services, the percentage variance between the correct repricing amount and the amount to which the PPO repriced the service.

A computer-implemented method for auditing an invoice includes a communication interface receiving information related to the invoice. The invoice includes charges for services provided by a service provider, relates to an insurance policy issued by an insurance company, and was repriced by a PPO. The information related to the invoice includes, for each of the services: an amount to which the PPO repriced the service; an identifier of a type of the service; an identifier of a service provider that provided the service; and an amount paid by the insurance company to a service provider for the service. The method further includes the communication interface receiving information that indicates a reimbursement rate schedule. The method further includes storing, in a memory device, the information related to the invoice and the information that indicates the reimbursement rate schedule. The method further includes a processor determining, for each of the service, a correct repricing amount based on the reimbursement rate schedule and the processor determining, for each of the services, a percentage variance between the correct repricing amount and the amount to which the PPO repriced the service. The method further includes a display device displaying, for each of the services, the percentage variance between the correct repricing amount and the amount to which the PPO repriced the service. The method further includes the processor determining a total variance amount for the invoice, wherein the total variance amount indicates a difference between the correct repricing amounts and the amounts paid by the insurance company to the service provider for the services. The method further includes the processor initiating an electronic funds transfer (EFT) payment to the service provider for the total variance amount.

A computer-readable medium has processor-executable instructions stored thereon which, when executed by at least one processor, will cause the at least one processor to perform a method for auditing an invoice. The invoice includes charges for services provided by a service provider, relates to an insurance policy issued by an insurance company, and was repriced by a business entity pursuant to a reimbursement rate schedule. The method includes obtaining information related to the invoice that includes, for each of the services: an amount to which the business entity repriced the service; an identifier of the invoice; and an identifier of a type of the service. The method further includes storing, in a memory device, the information related to the invoice. The method further includes determining, for each of the services, a correct repricing amount based on the reimbursement rate schedule and determining, for each of the services, a percentage variance between the correct repricing amount and the amount to which the business entity repriced the service. The method further includes displaying, via a display device, the percentage variance for each of the services between the correct repricing amount and the amount to which the business entity repriced the service.

### BRIEF DESCRIPTION OF THE DRAWINGS

A more detailed understanding may be had from the following description, given by way of example in conjunction with the accompanying drawings wherein:

FIG. 1 shows an example architecture that may be used for auditing repriced invoices;

FIG. 2 shows user interface elements that receive user input that specifies the scope of an audit;

FIG. 3 shows user interface elements that display information related to repriced invoices;

FIGS. 4A-4B show user interface elements that may be used to manage data during an audit;

FIG. 5 shows user interface elements that display information related to the audit of an invoice;

FIG. 6 shows user interface elements that display information related to the audit of a number of invoices that were repriced by a PPO;

FIG. 7 shows a method for performing an audit of repriced invoices;

FIG. 8 shows a computing device that may be used to implement the features described herein; and

FIG. 9 shows a tablet computer that is a more specific example of the computing device of FIG. 8.

### DETAILED DESCRIPTION

Disclosed herein are processor-executable methods, computing systems, and related technologies that may be used to audit invoices that have been repriced by a PPO. The invoices relate to services that were rendered pursuant to a workers' compensation insurance policy issued by an insurance company, and data related to invoices that have been repriced by PPOs are stored in a database that is managed by the insurance company. An audit application is used to set parameters that define the scope of an audit. The parameters may include, for example, a time period for the invoices that will be included in the audit and a PPO to be audited. The audit application obtains the data from the database that corresponds to the specified audit scope. Then, the obtained data is audited to determine whether the invoices were correctly repriced. After the auditing is performed, reports may be generated based on the audit results. Further, actions may be taken based on the audit results, such as reimbursing service providers for underpaid invoices and/or updating contracts between the insurance company and PPOs.

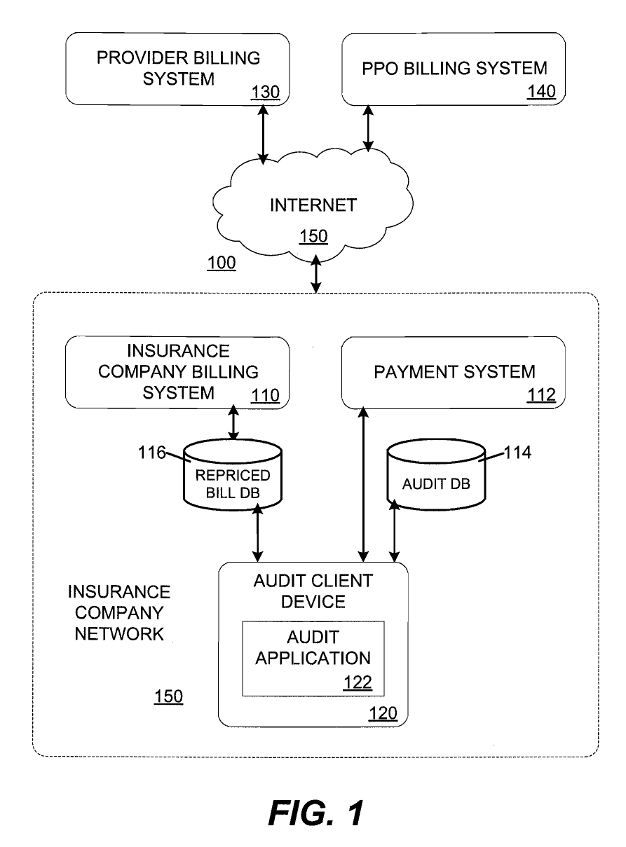

FIG. 1 shows an example architecture 100 that may be used for auditing repriced medical invoices. The example architecture 100 includes a service provider billing system 130, a PPO billing system 140, an insurance company network 150, an insurance company billing system 110, a payment system 112, an audit database 114, a repriced bill database 116, an audit client device 120, and the Internet 160. In the architecture 100 of FIG. 1, the insurance company network 150, as well as all of the components shown in the insurance company network 150 (i.e., the insurance company billing system 110, payment system 112, repriced bill database 116, audit database 114, and audit client device 120), are under the control of and/or operated by employees of an insurance company. The service provider billing system 130 is under the control of and/or operated by employees of a service provider that provides health services pursuant to workers' compensation insurance policies issued by the insurance company. The PPO billing system 140 is under the control of and/or operated by employees of a PPO of which the service provider is a member and which the insurance company has contracted with.

Information related to invoices that have been repriced by the PPO billing system 140 is stored in the repriced bill database 116. The information stored in the repriced bill database 116 may include, for each of a number of invoices, information such as the nature of each of the services that gave rise to the invoice, the amount that was initially charged for each of the services on the invoice, the amount that the PPO repriced the charge for each of the services, and/or other information. As will be described in further detail below, an audit application 122 in the audit client device 120 provides a graphical user interface that may be used by an operator of the audit client device 120 to audit the data in the repriced bill database 116. The repriced bill database 116 may also store digital images of the invoices that have been repriced, digital images of the contract documents that define the relationships between the insurance company and the PPOs, and/or one or more data models that describe attributes of the contracts between the insurance company and the PPOs.

An audit of the data in the repriced bill database 116 includes, among other tasks, determining whether the invoices were repriced accurately. In other words, an audit may include, for each of the invoices being audited, analyzing the invoice to determine what the invoice appropriately should have been repriced to according to the PPO's reimbursement rate schedule, and then determining whether the PPO had repriced to the same amount. The graphical user interface displayed by audit application 122 includes display elements that allow the operator of the audit client device 120 to set the parameters for an audit (e.g., to select a time period and a PPO to audit), to review repriced bill data, to collect and store comparison data generated during the audit, and to generate reports and other results data related to the audit.

When the service provider that controls the provider billing system 130 wants to issue an invoice for services rendered according to a policy issued by the insurance company, the service provider billing system 130 sends an electronic invoice to the insurance company billing system 110 via the Internet 160. The insurance company billing system 110 may then perform bill adjudication processing to ensure, for example, that the insurance company is responsible for paying the invoice. The insurance company billing system 110 may also reprice the invoice. In some instances, state law that is applicable to the invoice may set a maximum fee that may be charged by service providers for a particular service in the context of workers' compensation insurance. In such an instance, the insurance company billing system 110 may reduce the charged amount for a service to be within the legal limit. The insurance company billing system 110 may then determine that, since the service provider is a member of the PPO, the invoice should be sent to the PPO for potential repricing. The insurance company billing system 110 then sends the invoice to the PPO billing system 140 via the Internet 160. The PPO billing system 140 determines whether the invoice should be repriced, based on the reimbursement rate schedule associated with the PPO. The PPO billing system 140 then sends the invoice back to the insurance company billing system 110 via the Internet 160, repriced (or not) as appropriate. If the invoice was repriced by the PPO billing system 140, the insurance company billing system 110 stores information related to the invoice in the repriced bill database 116. The communications described above as taking place between the service provider billing system 130, insurance company billing system 110, and the PPO billing system 140 may be performed using a technology such as ANSI ASC X12 technology, and/or any other appropriate Electronic Data Interchange (EDI) technology.

The audit client device 120 may be a desktop computer, a laptop computer, a tablet computer, or any other appropriate type of computing device or data processing device. The audit client device 120 includes one or more processors (not depicted), and may include one or more storage devices (not depicted), one or more memory devices (not depicted), and/or one or more computer-readable media (not depicted). The audit client device 120 may also include and/or be connected to one or more input devices (not depicted) and/or one or more display devices (not depicted). The data storage devices, memory devices, and/or computer-readable media store an audit application 122. The audit application 122 may be a processor-executable software application and may be or include, by way of example, one or more executable programs, one or more functions, one or more method calls, one or more procedures, one or more routines or sub-routines, one or more processor-executable instructions, and/or one or more objects or other data structures. Alternatively or additionally, the audit application 122 or portions of the audit application may be implemented using a spreadsheet application and one or more macros. Spreadsheet applications that may be used for this purpose include Microsoft Excel, OpenOffice Calc, or any other appropriate spreadsheet application. For convenience in description, the audit application 122 is described herein as performing a number of actions. However, it should be understood that the actions described herein as performed by the audit application 122 are performed by the one or more processors in the audit client device 120, in conjunction with the above-mentioned other components (e.g., the data storage devices, memory devices, input devices, and/or display devices, as appropriate) that are included in or connected to the audit client device 120.

The repriced bill database 116 may be spread across one or more computer-readable media, and may be or include one or more relational databases, hierarchical databases, object-oriented databases, one or more flat files, one or more spreadsheets, and/or one or more structured files. The audit database 114 may also be spread across one or more computer-readable media, and may also be or include one or more relational databases, hierarchical databases, object-oriented databases, one or more flat files, one or more spreadsheets, and/or one or more structured files. The repriced bill database 116 and/or the audit database 114 may be managed by one or more database management systems (not depicted), which may be based on technologies such as Microsoft SQL Server, MySQL, PostgreSQL, Oracle Relational Database Management System (RDBMS), a NoSQL database technology, and/or any other appropriate technologies.

The payment system 112 is used by the insurance company to make payments to service providers for services rendered pursuant to policies issued by the insurance company. The payment system 112 may execute payments by communicating, via the Internet 160, with payment processing systems (not depicted) that are operated by banks or other financial institutions. As will be described in further detail below, the audit application 112 may, in some circumstances, determine that a payment should be made to a service provider, and the audit application 112 may initiate the payment by communicating with the payment system 112.

The communications described herein as taking place between the insurance company billing system 110, the payment system 112, the repriced bill database 116, the audit database 114, and the audit client device 120 are performed via the insurance company network 150. Although described for convenience as a single network, the insurance company network 150 may be or include one or more private wired or wireless networks that are under the control of and/or operated by the insurance company. The one or more private wired or wireless networks may be based on, for example, technologies such as Ethernet and/or Institute of Electrical and Electronics Engineer (IEEE) 802.11 technologies.

In a variation on the example architecture 100 of FIG. 1, the audit client device 120 can also operate outside of the insurance company network 150, and the communications described herein as taking place between the audit client device 120 and the repriced bill database 116, audit database 114, and/or the payment system 112 may be performed via the Internet 160. This may occur, for example, where the operator of the audit client device 120 performs an audit using the audit client device 120 at a location belonging to the service provider or the PPO. When operating outside of the insurance company network 150, the audit client device 120 may communicate with the elements 112, 114, 116 within the insurance company network using technology such as Virtual Private Network (VPN) technology, other remote client technology, and/or any other appropriate technology.

For convenience of description, the example architecture 100 of FIG. 1 shows a single service provider billing system 130 and a single PPO billing system 140. However, the insurance company that controls the elements 110, 112, 114, 116 in the insurance company network 150 may receive invoices from many different service providers and have relationships with additional other PPOs. Accordingly, the example architecture 100 may include other service provider billing systems (not depicted) that are operated by other services providers, as well as other PPO billing systems (not depicted) that are operated by other PPOs. The insurance company billing system 110 may communicate with these other service provider billing systems and PPO billing systems in the same or a similar way as described above with reference to the communications between the insurance company billing system 110 and the service provider billing system 130 and PPO billing system 140. The repriced bill database 116 may then include data related to repriced invoices from the other service providers and/or which were repriced by the other PPOs. Further, the example architecture 100 may include multiple other audit client devices (not depicted), with the same or similar characteristics as the audit client device 120 described herein. In such an instance, multiple employees of the insurance company can simultaneously work on the same audit, each employee operating their own audit client device, each of which may include its own instance of an audit application with the same or similar characteristics as the audit application 122 described herein.

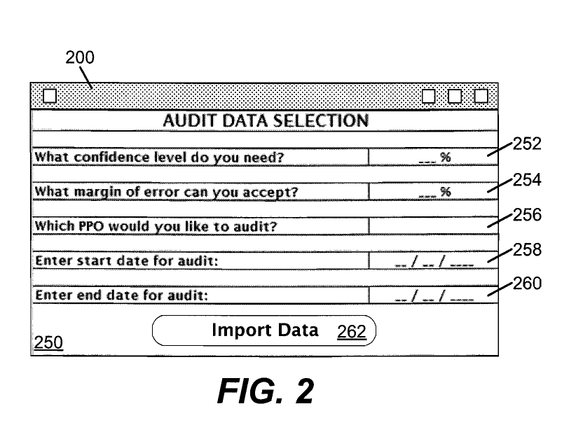

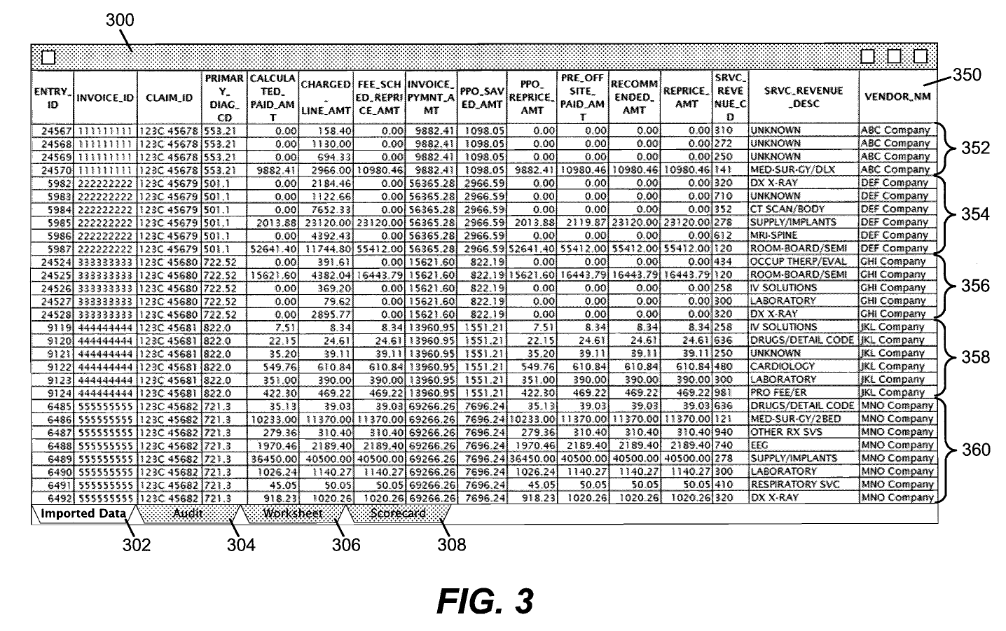

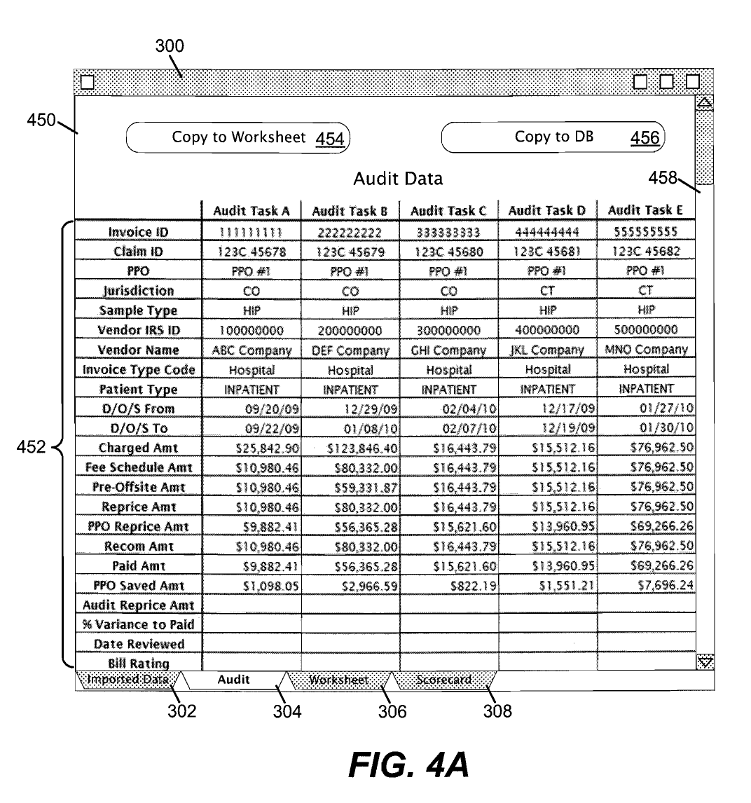

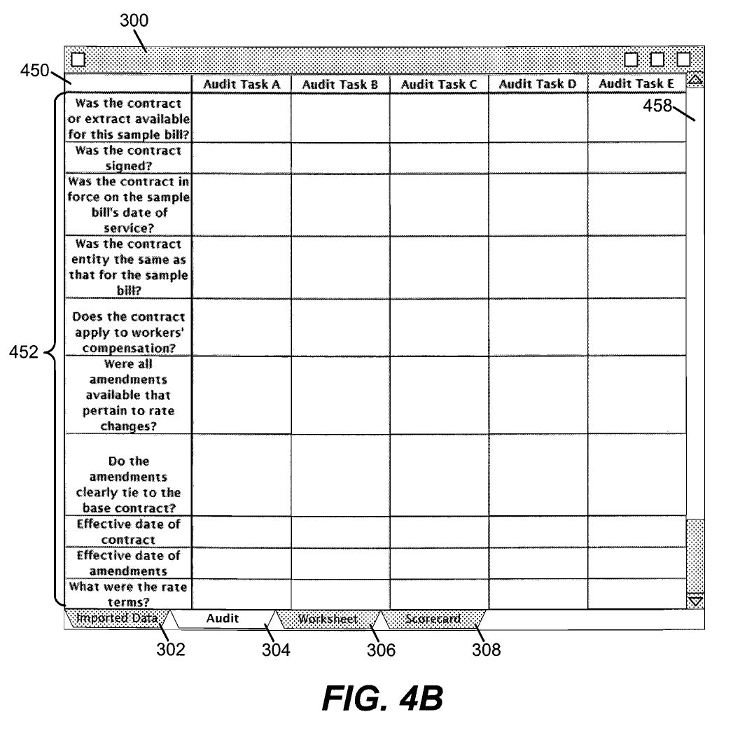

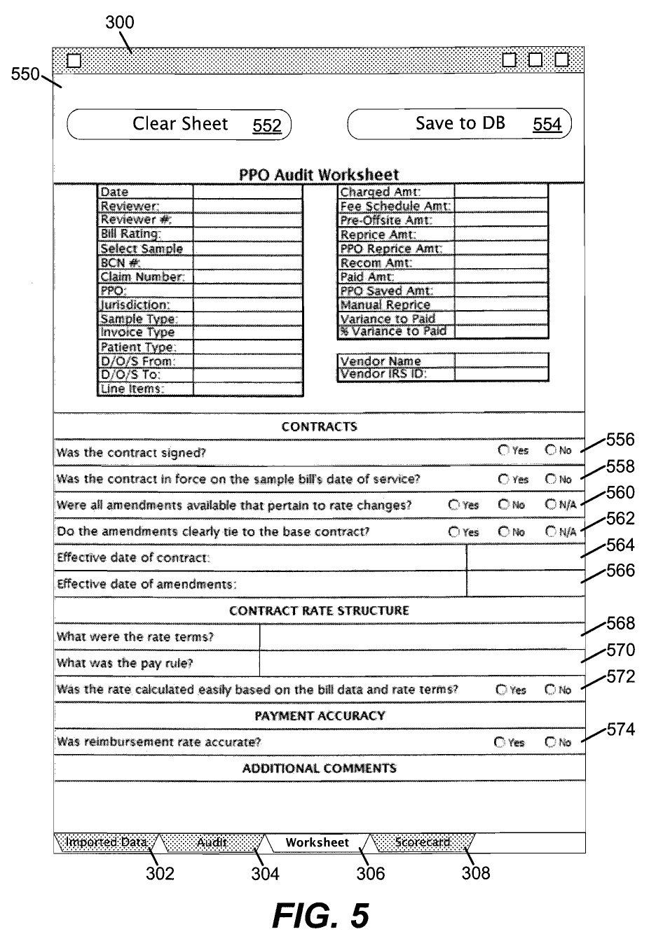

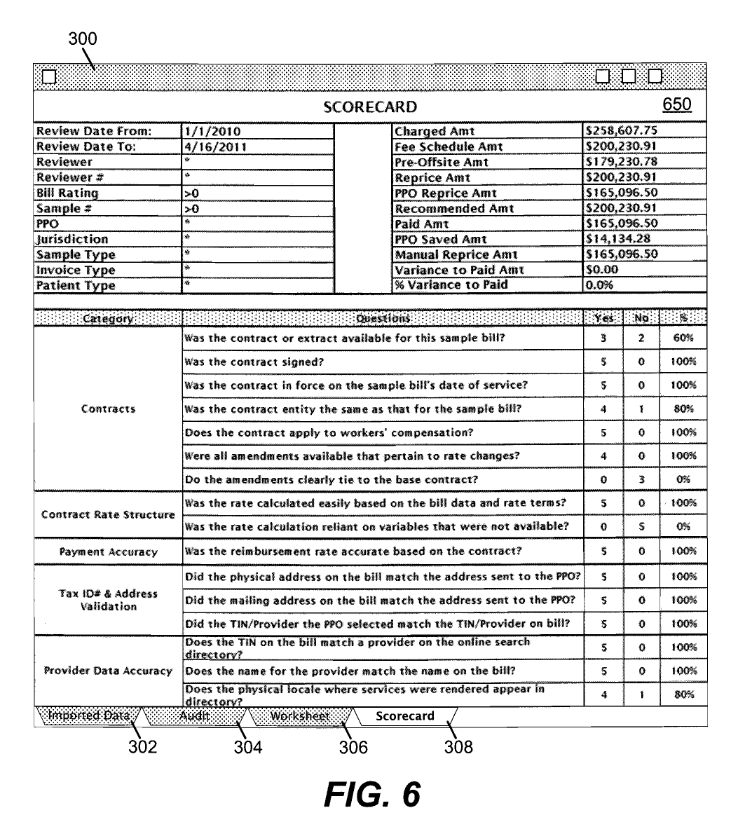

FIGS. 2-6 show a number of graphical user interface elements that are displayed by the audit application 122. FIG. 2 shows an audit data selection window 200 that receives user input for defining the scope of an audit, and FIGS. 3-6 show an audit application window 300 that may be used for managing data generated during an audit. The audit application window 300 shows a tabbed document interface (TDI) design, and includes four tab buttons: an Imported Data tab button 302, Audit tab button 304, Worksheet tab button 306, and Scorecard tab button 308. Each of the tab buttons 302, 304, 306, 308 corresponds to a different panel that is displayed within the audit application window 300. Specifically, the Imported Data tab button 302 corresponds to the Imported Data panel 350 that is shown in FIG. 3, the Audit tab button 304 corresponds to the Audit panel 450 shown in FIGS. 4A-4B, the Worksheet tab button 306 corresponds to the Worksheet panel 550 shown in FIG. 5, and the Scorecard tab button 308 corresponds to the Scorecard panel 650 shown in FIG. 6. When one of the tab buttons 302, 304, 306, 308 is selected, the audit application window 300 displays the panel 350, 450, 550, 650 that corresponds to the selected tab button 302, 304, 306, 308. The audit data selection window 200 and each of the panels 350, 450, 550, 650 in the audit application window are described in further detail below.

As shown in FIG. 2, the audit data selection window 200 includes an audit data selection panel 250 that includes five input fields 252, 254, 256, 258, 260 that receive user input, as well as an Import Data button 262. The input fields 252, 254, 256, 258, 260 may receive input data such as a required confidence level in the audit, an acceptable margin of error, the PPO who will be audited, a start date for the invoices that will be included in the audit, and an end date for the invoices that will be included in the audit. The five input fields 252, 254, 256, 258, 260 shown in FIG. 2 are shown as an example, and the data selection panel 250 may include any number or any combination of input fields that solicit data for specifying the scope of the audit.

In response to a user input that indicates a selection of the Import Data button 262, the audit application 122 obtains data from the repriced bill database 116 as specified in the input fields 252, 254, 256, 258, 260, and stores the obtained data in the audit database 114. As one example, if the scope of the audit is set for a particular time period and for a particular PPO, then the audit 122 may import data that relates to all of the invoices for the specified PPO in the specified time period. In an instance where the data that describes the scope of the audit includes parameters that specify a desired confidence level and/or acceptable margin of error, the audit application 122 analyzes the data in the repriced bill database 116, and obtains data from the repriced bill database 116 that corresponds to the number of invoices that will provide the specified confidence level and/or margin of error. Importing data from the repriced bill database 116 may also include obtaining other data (such as digital images of the invoices that will be audited, digital images and/or data models related to the contracts between the insurance company and the PPOs that will be included in the audit) from the repriced bill database 116 and adding this other data to the audit database 114.

Referring now to FIG. 3, the Imported Data panel 350 in the audit application window 300 of FIG. 3 shows example data that may be imported by audit application 122 from the repriced bill database 116. The example data shown in FIG. 3 may be obtained from the repriced bill database 116 using, for example, the audit data selection window 200 and related features described above with reference to FIG. 2.

The Imported Data panel 350 of FIG. 3 is arranged in a grid format. Each row in the grid corresponds to a single service that was included on a repriced invoice, and each column in the grid corresponds to an attribute of the service. The first four rows in the grid in the Imported Data panel 302 (corresponding to a first region 352) show data for four distinct services from the same invoice (an example invoice with an identifier of “111111111.”) The Imported Data panel 350 also includes four other regions 354, 356, 358, 360 each of which corresponds to services from three different example invoices (with identifiers of “222222222,” “333333333,” “444444444,” and “555555555,” respectively). Descriptions for the data in each of the columns in the grids are provided below in Table 1.

TABLE 1

| | |
|---|---|
| ENTRY_ID | Each row in the grid corresponds to |
| | a different service; this column |
| | indicates a unique identifier for |
| | each of the services. |
| INVOICE_ID | For a given service, this indicates |
| | an identifier of the invoice on |
| | which the charge for the |
| | service was included. |
| CLAIM_ID | For a given service, this indicates |
| | an identifier of the insurance |
| | claim associated with the |
| | service. |
| PRIMARY_DIAG_CD | For a given service, this is a code |
| | that specifies the nature of the |
| | injury that the service relates |
| | to. This may be an International |
| | Statistical Classification of |
| | Diseases and Related Health |
| | Problems (ICD) code. |
| CALCULATED_PAID_AMT | For a given service, this indicates |
| | the amount that the insurance |
| | company paid the service |
| | providers for the service. |
| CHARGED_LINE_AMT | For a given service, this indicates |
| | the amount that the service |
| | provider originally charged for |
| | the service. |
| FEE_SCHED_REPRICE_AMT | For a given service, this indicates |
| | the amount the insurance |
| | company repriced the service |
| | to, based on a state fee |
| | schedule. |
| INVOICE_PYMNT_AMT | For a given service, this column |
| | indicates the final amount |
| | that the insurance paid on |
| | the entire invoice on which |
| | the charge for the service was |
| | included. |
| PPO_SAVED_AMT | For a given service, this indicates |
| | the difference between the |
| | original charge for the service |
| | from the service provider and |
| | the charge as repriced by |
| | the PPO. |
| PPO_REPRICE_AMT | For a given service, this indicates |
| | the amount that the PPO |
| | repriced the charge for this |
| | service to. |
| PRE_OFFSITE_PAID_AMT | For a given service, this indicates |
| | the amount for that the |
| | insurance company sent to |
| | the PPO as the basis for the |
| | PPO's repricing of the service. |
| | This amount may be different |
| | from the amount originally |
| | invoiced for the service by |
| | the service provider, as the |
| | original amount may have |
| | been modified by the insurance |
| | company based on, for example, |
| | a state fee schedule and/or |
| | other factors. |
| RECOMMENDED_AMT | For a given service, this indicates |
| | the amount recommended by |
| | the insurance company as an |
| | appropriate charge for the |
| | service based on the applicable |
| | state fee schedule. |
| REPRICE_AMT | For a given service, this indicates |
| | the amount that the PPO |
| | repriced the charge for this |
| | service to. |
| SRVC_REVENUE_CD | For a given service, this is a code |
| | that identifies the service. |
| | May be a Current Procedural |
| | Terminology (CPT) code or |
| | a Healthcare Common |
| | Procedure Coding System |
| | (HCPCS) code. |
| SRVC_REVENUE_DESC | For a given service, this indicates |
| | a description of the service. |
| VENDOR_NM | For a given service, this indicates |
| | the name of the service |
| | provider who rendered |
| | the service. |
| VENDOR_IRS_NBR | For a given service, this is an |
| | Internal Revenue Service (IRS) |
| | identifier associated with the |
| | service provider who rendered |
| | the service. |

Although not shown in FIG. 3, the Imported Data panel 350 may also include columns that include, for each of the services indicated in the Imported Data panel 350, one or more of the following: an invoice date; a service start date and time; a service end date and time; an invoice start date and time; an invoice end date and time; a PPO account number; a PPO network identifier; whether the invoice relates to an inpatient service or an outpatient service; and/or other information.

FIGS. 4A-4B show the Audit panel 450 of the audit application window 300. The Audit panel 450 shown in FIG. 4A includes a number of graphical user interface elements that may be used to manage data during an audit of the data shown in the Imported Data panel 350. The Audit panel 450 includes a Copy to Worksheet button 454, a Save to Database button 456, and a scrollbar 458. The Audit Panel 450 also includes a grid area 452 that includes four columns, the “Audit Task A” column, “Audit Task B” column, and so on. Each of these columns corresponds to the audit of one of the example invoices that are referenced in the Imported Data panel 350 of FIG. 3. For example, the “Audit Task A” column corresponds to the audit of the invoice with the identifier “111111111,” while the “Audit Task B” column corresponds to the audit of the invoice with the identifier “222222222,” and so on. The grid area 452 also includes a number of rows, each of which includes a field that corresponds to an attribute of an invoice being audited. For example, the “PPO Reprice Amount” includes fields that indicate what the PPO repriced the invoices to.

Many of the rows in the grid area 452 are pre-filled by the audit application 122 based on the data stored in the audit database 114 and/or shown in the Imported Data panel 350 of FIG. 3. The fields in the “Audit Reprice Amount” row are, however, not filled in by the audit application 122. Instead, the operator of the audit application 122 analyzes, for each of the invoices, the data related to the invoice shown in the “Audit Task” column and the PPO reimbursement rate schedule that is applicable to the invoice, and independently determines the correct amount to which the PPO should have repriced the invoice. The operator of the audit client device 120 may then input the determined amount into the corresponding field in the “Audit Reprice Amount” row in the column that corresponds to a given invoice. After the operator has provided input into this field, the audit application 122 may then fill in the “% Variance to Paid” field to indicate the percentage difference between the values in the “Audit Reprice Amount” row and the “PPO Reprice Amount” row. Further, the operator of the audit client device 120 may provide input into the “Date Reviewed” field and “Bill Rating” field to indicate when the audit of the invoice was performed and the overall rating of the invoice.

FIG. 4B shows a further portion of the Audit panel 450 and grid area 452 shown in FIG. 4A. The rows in the grid area 452 shown in FIG. 4B are below the rows in the grid area 452 shown in FIG. 4A, and the operator of the audit client device 120 may navigate to the portion of the grid area 452 shown in FIG. 4B by using the scrollbar 458 included in the Audit panel 450. As shown in FIG. 4B, the rows in this lower portion of the grid area 452 include fields that indicate information related to the contracts between the insurance company and the PPOs. The operator of the audit client device 120 may analyze the contracts between the insurance company and the PPOs and provide corresponding input into the fields shown on FIG. 4B.

In addition to or as a variation on the features described above with reference to FIGS. 4A-4B, instead of the operator of the audit client device 120 determining information to be entered into the empty rows shown in FIGS. 4A-4B, the audit application 122 may determine some or all of the information to be entered into these rows. This may be performed, for example, by the audit application 122 obtaining a data model from the audit database 114 that represents characteristics of the contract between the insurance company and the PPO and/or characteristics of the contracts that may exist between the PPO and service providers. The data model may include, for example, a reimbursement rate schedule and/or other information. A reimbursement rate schedule in the data model may include information that indicates, for each of a number of services, a rate that the insurance company has agreed to pay service providers for the service. The reimbursement rate schedule may be represented in a number of different ways and may indicate, for example, correspondences between service identifiers (such as CPT codes) and charges for the services identified by the identifiers. The audit application 122 may then determine, based on this data model and the data stored in the audit database 114 (including the information shown in the Imported Data panel 350 of FIG. 3), the information required to fill in one or more of the empty rows shown in FIGS. 4A-4B. This may include determining, for each of the services associated with an invoice, the correct repricing amount (i.e., the amount to which the PPO should have repriced the service according to the reimbursement rate schedule.) This may also include determining a total variance amount for the invoice (i.e., the difference between the total of the amounts the PPO repriced to and the total of the correct repricing amounts). Alternatively or additionally, this may include determining a total percentage variance for the invoice (i.e., the percentage variance between the total of amounts that the PPO repriced to and the total of the correct repricing amounts). In an instance where the audit application 122 determines a total variance amount and/or a total percentage variance, the audit application 122 may add the total variance amount and/or the total percentage variance to the appropriate fields in the “Audit Reprice Amount” and “% Variance to Paid” rows, respectively, in the grid area 452 shown in FIG. 4A.

The data model obtained by the audit application 122 from the audit database 114 may also include information that indicates rate terms under the contracts between the PPO and service providers. In such an instance, the audit application may add information from the data model to the “What were the rate terms?” row shown in the grid area 452 in FIG. 4B. Alternatively or additionally, the audit application 122 may obtain a digital image of the contract document that defines the relationship between the insurance company and the PPO, and then analyze the image document to determine information required to fill in one or more of the empty rows shown in FIGS. 4A-4B. As an example, the audit application 122 may search the image document to determine whether the document includes a “Signature” area and whether the area includes a signature. The audit application 122 may then add information to the “Was the contract signed?” row shown in the grid area 452 in FIG. 4B.

Referring again to FIG. 4A, the audit application 122 may receive user input from the operator of the audit client device 120 via the Save to Database button 456 and the Copy to Worksheet button 454. In response to a selection of the Save to Database button 456, the audit application stores the information in the grid area 452 in the Audit panel 450 in the audit database 114. In response to a selection of the Copy to Worksheet button 454, if one of the columns in the grid area 452 in the Audit panel is selected, then the audit application 122 copies information from one of the columns in the grid area 452 in the Audit panel 450 into the Worksheet panel 550 of FIG. 5.

FIG. 5 shows the Worksheet panel 550 of the audit application window 300. The Worksheet panel 550 as shown in FIG. 5 includes a number of questions and corresponding fields 556, 558, 560, 562, 564, 566, 568, 570, 572, 574 that relate to the audit of a single invoice. The Worksheet panel 550 also includes a Clear Sheet button 552 and a Save to Database button 554.

The audit application 122 populates the fields 556, 558, 560, 562, 564, 566, 568, 570, 572, 574, 576, 578 in the Worksheet panel 550 based on information shown in the Audit panel 450 of FIGS. 4A-4B. This may be performed by the audit application 122 in response to a selection of the Copy to Worksheet button 454 in the Audit Panel 450, and this may include copying data from fields in the grid area 452 of the Audit panel 450 into corresponding fields in the Worksheet panel 550. As one example, in an instance where the “Audit Task A” column in the Audit Panel is selected when an input event on the Copy to Worksheet button 454 is received, the audit application 122 would copy the data from the “Was the contract signed?” row (from FIG. 4B) in the “Audit Task A column” to the “Was the contract signed?” field 556 in the Worksheet panel 550. The audit application 122 may also perform analogous copying for the other input fields 558, 560, 562, 564, 566, 568, 570, 572, 574.

In response to a selection of the Clear Sheet button 552, the audit application 122 removes any data that is present in the input fields 556, 558, 560, 562, 564, 566, 568, 570, 572, 574 in the Worksheet panel. In response to a selection of the Save to Database button 554, the audit application 122 stores information in the input fields 556, 558, 560, 562, 564, 566, 568, 570, 572, 574 to the audit database 114.

FIG. 6 shows the Scorecard panel 650 of the audit application window 300. While the Worksheet panel 550 of FIG. 5 shows information related to a single invoice, the Scorecard panel 650 shows information related to all of the invoices that are represented in the Audit panel 450 of FIGS. 4A-4B. When information is entered into the grid area 452 of the Audit panel 450 and/or added to the grid area 452 by the audit application 122, the audit application 122 updates the Scorecard panel 650 accordingly. For example, when the operator of the audit client device 120 adds information to the “Was the contract signed?” row (from FIG. 4B) in the Audit panel 450, the audit application 122 updates the “Was the contract signed?” fields in the Scorecard panel 650 accordingly.

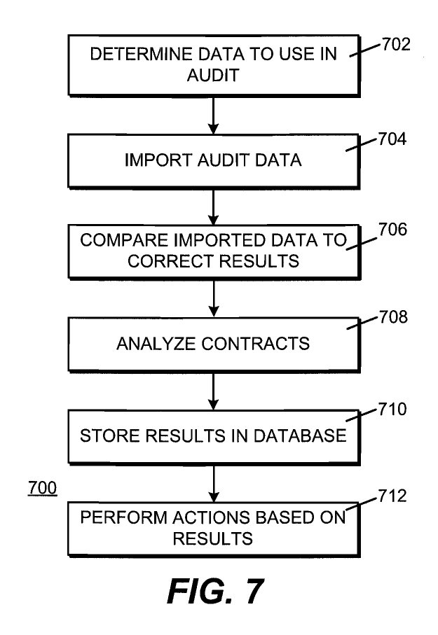

FIG. 7 shows a method 700 for performing an audit of repriced invoices that may be performed using the audit application 122. The method of FIG. 7 begins with determining the scope of the data to be audited (step 702). This may include, for example, the audit application 122 displaying the audit data selection window 200 of FIG. 2 and receiving input data from the operate of the audit client device 120 that specifies the scope of the audit.

Next, the audit application 122 obtains data from the repriced bill database 116 that corresponds to the scope of the audit, and stores the data in the audit database 114 (step 704). This may include, for example, determining the appropriate number of invoices to include in the audit based on a desired confidence level and/or acceptable margin of error that were specified in step 702.

Next, the imported data is compared to the correct outcomes for repricing the invoices (step 706). This may include, for example, an operator of the audit client device 120 analyzing the applicable PPO reimbursement rate schedule and determining how repricing should have been performed according to the reimbursement rate schedule. Then, the operator may compare the repricing performed by the PPO to how repricing should have been performed. The operator may then provide the data that indicates the results of this analysis as input data to the Audit panel 450 of the audit application window 300. After the data that indicates the results of the analysis is received in the Audit panel 450 of the audit application window 300, the audit application 122 may determine, for each of the services for which data is entered, a percentage variance between the correct repricing amount and the amount to which the PPO repriced the service.

As a variation on step 706, some or all of the analysis described above as performed in step 706 by the operator of the audit client device 120 may be performed instead by the audit application 122. In such an instance, step 706 may include the audit application 122 obtaining a data model from the audit database 114 that describes reimbursement rate schedule and other related information, and use the data model to determine whether the invoices were repriced by the PPO correctly.

After the imported data is compared to the correct outcomes for repricing the invoices (step 706), the contracts between the PPOs and the insurance company are analyzed (step 708). This may include the operator of the audit client device 120 analyzing the contracts between the PPO and the insurance company to determine, for example, whether the contracts are signed, whether amendments to the contract closely tie to the contract, and/or other information. Alternatively or additionally, this may include the operator of the audit client device 120 determining information such as the information solicited by the questions shown in the Audit panel 450 of the audit application window 300 in FIG. 4B. The operator may then provide the data that indicates the results of this analysis as input data to the Audit panel 450 of the audit application window 300.

As a variation on step 708 as described above, some or all of the analysis described above as performed in step 708 by the operator of the audit client device 120 may be performed instead by the audit application 122. In such an instance, audit application 122 may retrieve a digital image of the contract document that defines the relationship between the insurance company and the PPO from the audit database 114, and use the digital image to determine characteristics of the contract.

Next, the conclusions of the analysis performed in step 706 and step 708 may be stored in the audit database 114 (step 708). This may be performed in a number of different ways. As one example, the operator of the audit client device 120 may select the Save to Database button 456 shown in the Audit panel 450 of the audit application window 300. In response to the selection of the Save to Database button 456, the audit application 122 copies the data shown in the Audit panel 450 to the audit database 114. As an alternative example, the following actions may be performed: The operator of the audit client device 120 may select a first column from the grid area 452 in the Audit panel 450 of the audit application window 300, and then select the Copy to Worksheet button 454. In response to the selection of the Copy to Worksheet button 454, the audit application 122 may copy the data in the selected column to the Worksheet panel 550 of the audit application window 300. The operator of the audit client device 120 may then select the Save to Database button 554 in the Worksheet panel 550. In response to the selection of the Save to Database button 554, the audit application 122 may copy the data in the Worksheet panel 550 to the audit database 114. Then, the above-listed actions may be repeated for each of the remaining columns in the grid area 452 in the Audit panel 450.

Then, one or more actions may be taken based on the information generated in step 706 and step 708 (step 712). As one example, the audit application 122 may analyze the results data and determine that a PPO had reduced an invoice by too much, and that a service provider had been underpaid for an invoice. In such a circumstance, the audit application 122 may, via the payment system 112 described above with reference to FIG. 1, initiate an electronic funds transfer (EFT) or other funds transfer to a bank account of the service provider that had been underpaid. Alternatively or additionally, step 712 may include the audit application 112 printing one or more reports that reflect the information generated in step 706 and/or step 708. This may include, for example, printing reports with a similar format as the format shown above in the Worksheet panel 550 of the audit application window 300 and/or the Scorecard panel 650 of the audit application window 300. The reports may be printed, for example, via a printer that is connected to the audit client device 120. As a further example, step 712 may include the audit application 122 transmitting a report (with a similar format as the format shown above in the Worksheet panel 550 of the audit application window 300 and/or the Scorecard panel 650 of the audit application window 300) to an employee of the insurance company as an attachment in an email message.

Alternatively or additionally, step 712 may include one or more employees of the insurance company, upon viewing the generated reports, determining that a contract with one of the PPOs needs updating. This may occur if, for example, a report indicates that a contract was not signed, that an amendment to a contract does not clearly tie to the original contract, or if a report indicates that some other aspect of a contract could be improved. In such an instance, employees of the insurance company may contact the PPO and work with the PPO to update the contract.

Alternatively or additionally, step 712 may include the audit application 122 determining, based on the results data, that repricing accuracy at the PPO should be improved. This may be based on, for example, the audit application 122 determining that the results data indicates a high average percentage variance across the invoices includes in the scope of the audit, or indicates that a certain number of invoices have percentage variances over a given threshold. The audit application 122 may then interact with a system such as a workflow system to indicate to one or more employees of the insurance company that the employees should contact the PPO to encourage the PPO to increase repricing accuracy.

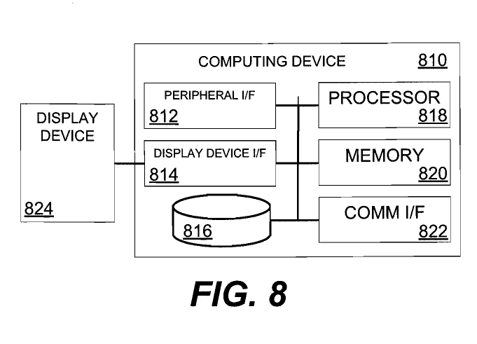

FIG. 8 shows an example computing device 810 that may be used to implement features describe above with reference to FIGS. 1-7. The computing device 810 includes a processor 818, memory device 820, communication interface 822, peripheral device interface 812, display device interface 814, and data storage device 816. FIG. 8 also shows a display device 824, which may be coupled to or included within the computing device 810.

The memory device 820 may be or include a device such as a Dynamic Random Access Memory (D-RAM), Static RAM (S-RAM), or other RAM or a flash memory. The data storage device 816 may be or include a hard disk, a magneto-optical medium, an optical medium such as a CD-ROM, a digital versatile disk (DVDs), or Blu-Ray disc (BD), or other type of device for electronic data storage.

The communication interface 822 may be, for example, a communications port, a wired transceiver, a wireless transceiver, and/or a network card. The communication interface 822 may be capable of communicating using technologies such as Ethernet, fiber optics, microwave, xDSL (Digital Subscriber Line), Wireless Local Area Network (WLAN) technology, wireless cellular technology, and/or any other appropriate technology.

The peripheral device interface 812 is configured to communicate with one or more peripheral devices. The peripheral device interface 812 operates using a technology such as Universal Serial Bus (USB), PS/2, Bluetooth, infrared, serial port, parallel port, and/or other appropriate technology. The peripheral device interface 812 may, for example, receive input data from an input device such as a keyboard, a mouse, a trackball, a touch screen, a touch pad, a stylus pad, and/or other device. Alternatively or additionally, the peripheral device interface 812 may communicate output data to a printer that is attached to the computing device 810 via the peripheral device interface 812.

The display device interface 814 may be an interface configured to communicate data to display device 824. The display device 824 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 814 may operate using technology such as Video Graphics Array (VGA), Super VGA (S-VGA), Digital Visual Interface (DVI), High-Definition Multimedia Interface (HDMI), or other appropriate technology. The display device interface 814 may communicate display data from the processor 818 to the display device 824 for display by the display device 824. As shown in FIG. 8, the display device 824 may be external to the computing device 810, and coupled to the computing device 810 via the display device interface 814. Alternatively, the display device 824 may be included in the computing device 800.

An instance of the computing device 810 of FIG. 8 may be configured to perform any feature or any combination of features described above as performed by the audit client device 120. Alternatively or additionally, the memory device 820 and/or the data storage device 816 may store instructions which, when executed by the processor 818, cause the processor 818 to perform any feature or any combination of features described above as performed by the audit application 122. Alternatively or additionally, each or any of the features described above as performed by the audit application 122 may be performed by the processor 818 in conjunction with the memory device 820, communication interface 822, peripheral device interface 812, display device interface 814, and/or storage device 816.

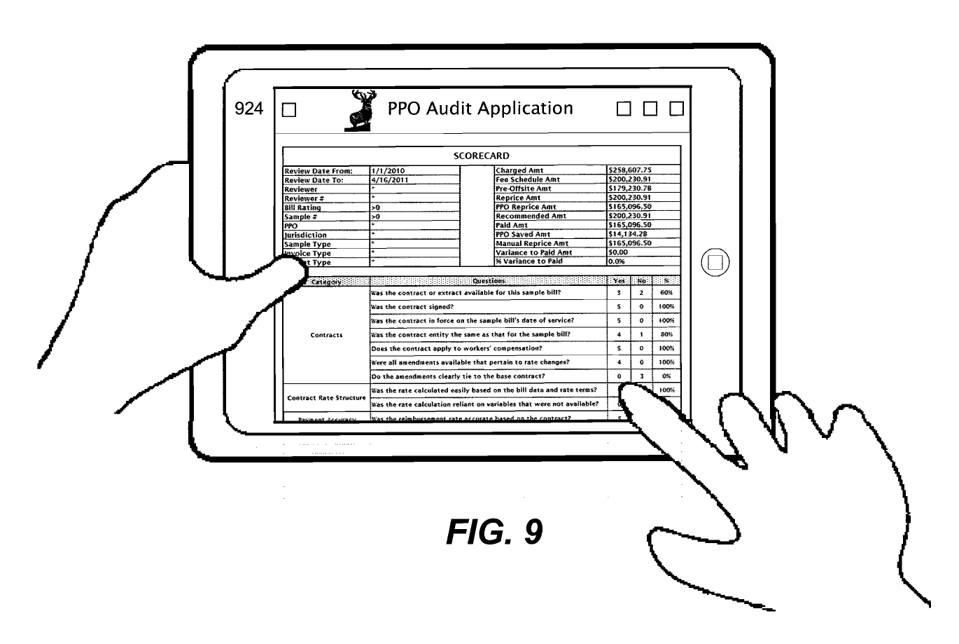

FIG. 9 shows a tablet computer 910 that is a more specific example of the computing device 810 of FIG. 8. The tablet computer 910 may include a processor (not depicted), memory device (not depicted), communication interface (not depicted), peripheral device interface (not depicted), display device interface (not depicted), storage device (not depicted), and touch screen display 924, which may possess characteristics of the processor 818, memory device 820, communication interface 822, peripheral device interface 812, display device interface 814, storage device 816, and display device 824, respectively, as described above with reference to FIG. 8. The touch screen display 924 may receive user input using technology such as, for example, resistive sensing technology, capacitive sensing technology, optical sensing technology, or any other appropriate touch-sensing technology.

Although examples are provided above that relate to workers' compensation insurance, the features described above with reference to FIGS. 1-9 may also be used, mutatis mutandis, in the context of automobile insurance, group medical insurance, and/or any other appropriate type of insurance. Further, although examples are provided above wherein invoices that were repriced by PPOs are audited, the features described above with reference to FIGS. 1-9 may also be used, mutatis mutandis, to audit invoices that were repriced by a repricing company, third party administrator (TPA), or any other type of business entity that performs repricing of invoices pursuant to insurance policies.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

Although the methods and features are described above with reference to the example architecture 100 of FIG. 1, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-9 may be used alone without the other features and elements or in various combinations with or without other features and elements. Sub-elements of the methods and features described above with reference to FIGS. 1-9 may be performed in any arbitrary order (including concurrently), in any combination or sub-combination.

1. A system for auditing a plurality of workers' compensation invoices that include charges for services provided by service providers, wherein the invoices relate to a workers' compensation insurance policy issued by an insurance company and were repriced by a Preferred Provider Organization (PPO), the system comprising:
a communication interface configured:
to receive information related to an invoice from the plurality of invoices, wherein the information related to the invoice includes, for each of a plurality of services charged on the invoice:
an amount to which the PPO repriced the service;
an identifier of the invoice;
a Current Procedural Terminology (CPT) code;
an identifier of a service provider that provided the service; and
an amount paid by the insurance company to the service provider for the service;
an identifier of a workers' compensation insurance claim associated with the service; and
to receive information that indicates a reimbursement rate schedule that indicates amounts that the insurance company will pay for services;
a processor configured:
to determine a correct repricing amount for each of the services based on the reimbursement rate schedule; and
to determine, for each of the services, a percentage variance between the correct repricing amount and the amount to which the PPO repriced the service; and
a display device configured to display, for each of the services, the percentage variance between the correct repricing amount and the amount to which the PPO repriced the service.

2. The system of claim 1, wherein the information related to the invoice further includes, for each of the services:
an amount to which the insurance company repriced the service pursuant to a state fee schedule;
an International Statistical Classification of Diseases and Related Health Problems (ICD) code; and
an amount originally charged by the service provider that provided the service.

3. The system of claim 1, wherein the information related to the invoice further includes, for each of the services:
an invoice date;
a service start date and time;
a service end date and time;
an invoice start date and time;
an invoice end date and time;
a PPO account number;
a PPO network identifier; and
whether the invoice relates to an inpatient service or an outpatient service.

4. The system of claim 1,
wherein the processor is further configured to determine a total percentage variance for the invoice based on the percentage variances, and
wherein the display device is further configured to display the total percentage variance for the invoice.

5. The system of claim 1,
wherein the processor is further configured to determine a total variance amount for the invoice, wherein the total variance amount indicates a difference between the correct repricing amounts and the amounts paid by the insurance company to the service provider for the services charged on the invoice, and
wherein the display device is further configured to display the total variance amount.

6. The system of claim 5, wherein the processor is further configured to initiate an electronic funds transfer (EFT) payment to the service provider for the total variance amount.

7. A computer-implemented method for auditing an invoice that includes charges for services provided by a service provider, wherein the invoice relates to an insurance policy issued by an insurance company and was repriced by a Preferred Provider Organization (PPO), the method comprising:
a communication interface receiving information related to the invoice, wherein the information related to the invoice includes, for each of the services:
an amount to which the PPO repriced the service;
an identifier of a type of the service;
an identifier of a service provider that provided the service; and
an amount paid by the insurance company to a service provider for the service; and
the communication interface receiving information that indicates a reimbursement rate schedule;
storing, in a memory device, the information related to the invoice and the information that indicates the reimbursement rate schedule;
a computer processor determining, for each of the service, a correct repricing amount based on the reimbursement rate schedule;
the computer processor determining, for each of the services, a percentage variance between the correct repricing amount and the amount to which the PPO repriced the service;
a display device displaying, for each of the services, the percentage variance between the correct repricing amount and the amount to which the PPO repriced the service;
the computer processor determining a total variance amount for the invoice, wherein the total variance amount indicates a difference between the correct repricing amounts and the amounts paid by the insurance company to the service provider for the services; and
the computer processor initiating an electronic funds transfer (EFT) payment to the service provider for the total variance amount.

8. The method of claim 7, wherein the information related to the invoice further includes, for each of the services, one or more of:
an identifier of an insurance claim associated with the service;
an amount to which the insurance company repriced the service pursuant to a state fee schedule;
an International Statistical Classification of Diseases and Related Health Problems (ICD) code; or
an amount originally charged by the service provider that provided the service.

9. The method of claim 7, wherein the information related to the invoice further includes, for each of the services, one or more of:
an invoice date;
a service start date and time;
a service end date and time;
an invoice start date and time;
an invoice end date and time;
a PPO account number;
a PPO network identifier; or
whether the invoice relates to an inpatient service or an outpatient service.

10. The method of claim 7, further comprising:
the computer processor determining a total percentage variance for the invoice based on the percentage variances, and
the computer processor displaying, via the display device, the total percentage variance for the invoice.

11. The method of claim 7, wherein the insurance policy is a workers' compensation insurance policy.

12. The method of claim 7, wherein the identifier of the type of the service is a Current Procedural Terminology (CPT) code.

13. A non-transitory computer-readable medium having processor-executable instructions stored thereon which, when executed by at least one processor, will cause the at least one processor to perform a method for auditing an invoice, the method comprising:
obtaining information related to the invoice, wherein
the invoice includes charges for services provided by a service provider,
the invoice relates to an insurance policy issued by an insurance company,
the invoice was repriced by a business entity pursuant to a reimbursement rate schedule, and
the information related to the invoice includes, for each of the services:
an amount to which the business entity repriced the service;
an identifier of the invoice; and
an identifier of a type of the service;
storing, in a memory device, the information related to the invoice;
determining, for each of the services, a correct repricing amount based on the reimbursement rate schedule;
determining, for each of the services, a percentage variance between the correct repricing amount and the amount to which the business entity repriced the service; and
displaying, via a display device, the percentage variance for each of the services between the correct repricing amount and the amount to which the business entity repriced the service.

14. The computer-readable medium of claim 13, wherein the information related to the invoice further includes, for each of the services, one or more of:
an identifier of the service provider;
an identifier of an insurance claim associated with the service;
an amount to which the insurance company repriced the service pursuant to a state fee schedule;
an International Statistical Classification of Diseases and Related Health Problems (ICD) code; or
an amount originally charged by the service provider that provided the service.

15. The computer-readable medium of claim 13, wherein the information related to the invoice further includes, for each of the services, one or more of:
an invoice date;
a service start date and time;
a service end date and time;
an invoice start date and time;
an invoice end date and time;
a business entity account number;
a business entity network identifier; or
whether the invoice relates to an inpatient service or an outpatient service.

16. The computer-readable medium of claim 13, wherein the method further comprises:
determining a total percentage variance for the invoice based on the percentage variances, and
displaying, via the display device, the total percentage variance for the invoice.

17. The computer-readable medium of claim 13, wherein the method further comprises:
determining a total variance amount for the invoice, wherein the total variance amount indicates a difference between the amounts paid by the insurance company to the service provider for the services and the correct repricing amounts, and
displaying the total variance amount via the display device.

18. The computer-readable medium of claim 17, wherein the method further comprises:
initiating an electronic funds transfer (EFT) payment to the service provider for the total variance amount.

19. The computer-readable medium of claim 13, wherein the insurance policy is a workers' compensation insurance policy.

20. The computer-readable medium of claim 13, wherein the identifier of the type of the service is a Current Procedural Terminology (CPT) code.

21. The computer-readable medium of claim 13, wherein the business entity is a Preferred Provider Organization (PPO), repricing company, or third party administrator (TPA).
